(19) United States
(12) Patent Application Publication
(10) Pub. No.: US 2026/0270241 A1
(43) Pub. Date: Sep. 10, 2026

(54) PRIVACY ROUTING SYSTEM

(71) Applicants: KONINKLIJKE KPN N.V., Rotterdam (NL); NEDERLANDSE ORGANISATIE VOOR TOEGEPAST-NATUURWETENSCHAPPELIJK ONDERZOEK TNO, 's Gravenhage (NL)

(72) Inventors: Mattijs Oskar Van Deventer, Leidschendam (NL); Sandesh Jayaprakash Manganahalli, Rijswijk (NL); Nicolaas Wijnand Keesmaat, Voorburg (NL); Erieke Weitenberg, 's Gravenhage (NL); Willem Adriaan De Kok, Groningen (NL)

(21) Appl. No.: 18/993,356

(22) PCT Filed: Jul. 5, 2023
(86) PCT No.: PCT/EP2023/068627

§ 371 Date: Jan. 10, 2025

(30) Foreign Application Priority Data
Jul. 11, 2022 (EP) 22184205.7

(51) Int. Cl. H04L 9/40

(52) U.S. Cl. CPC H04L 63/0428

(57) ABSTRACT

A method comprises receiving (103) first cryptographic information and second cryptographic information at a device (1) of a first user and transmitting (109) a message to a privacy routing system (21). The first cryptographic information comprises a receiver identifier encrypted with a cryptographic key associated with the privacy routing system. The message comprises the receiver identifier encrypted with the cryptographic key and fourth cryptographic information which has been determined based on the second cryptographic information. The method further comprises decrypting (113) the receiver identifier at the privacy routing system, identifying (115), at the privacy routing system, a second user based on the decrypted receiver identifier, validating (117) the fourth cryptographic information, and forwarding (119) the message to a device (11) of the second user based on a result of the validation of the fourth cryptographic information.

### FIELD OF THE INVENTION

The invention relates to a method of routing messages via a privacy routing system.

The invention further relates to a first user device, a second user device, and a privacy routing system for use in such a method.

The invention also relates to computer program products enabling a first user device, a second user device, and a privacy routing system to perform steps of such a method.

### BACKGROUND OF THE INVENTION

Communication identifiers are a privacy pain. If a user shares an email address or phone number with a counterparty, then that counterparty can continue bothering this user via email or phone long thereafter. Even worse, the counterparty can share the user's communication identifiers with third parties, who can use them for spam, phishing and other privacy-invading practices. Moreover, counterparties and third parties can use the user's contact details for correlation, which enables them to combine data about the user in ways that may turn out negatively for the user. IP addresses also allow easy correlation, as ISPs rarely rotate IP addresses.

Gmail provides a basic solution for the spam problem. Gmail supports “task-specific” email addresses, which can be simply created by adding a “+”. For example, the email address johnsmith@gmail.com would be enhanced into johnsmith+news@gmail.com when signing up at an untrusted website. This makes it easy to filter out mail to this specific address, e.g., mail from an untrusted source. Whereas this solution is effective against stupid spam, it does not prevent against more clever correlation or spam, as the semantics of the “+” is easy to circumvent. Moreover, the solution requires a lot of work and administration from the users.

Another solution to prevent spam is the use of Decentralized IDentifiers (DIDs), a W3C proposed recommendation (https://w3c.github jo/did-core/). The blog “Self-Sovereign Identity—the good, the bad and the ugly” (“https://blockchain.tno.nl/blog/self-sovereign-identity-the-good-the-bad-and-the-ugly/”) discloses that a web shop could publish a public DID/DID Document (DDO) to receive encrypted and signed communication from its customers, which a citizen could use to negotiate a DID-pair with that web shop that would enable either to set up private, secure and authenticated communications channels with the other at a later point in time, effectively making logins obsolete.

The blog further discloses that by compartmenting all communication via DID pairs, spam may be prevented. If a service provider starts spamming the user via a previously established DID pair, the user can instruct their user agent application to ignore it, so the service provider can no longer reach the user. However, this solution requires direct communication between the user and the webshop, which reduces privacy, as it allows the webshop to make privacy-invading message correlations.

### SUMMARY OF THE INVENTION

It is a first objective of the invention to provide a method, which can be used to route incoming messages to the proper devices, while enabling users to block spam, without enabling third parties to correlate messages addressed to the same recipient.

It is a second objective of the invention to provide a privacy routing system, which can route incoming messages to the proper devices, while enabling users to block spam, without enabling third parties to correlate messages addressed to the same recipient.

In a first aspect of the invention, a method of routing messages via a privacy routing system comprises receiving first cryptographic information and second cryptographic information at a device of a first user, the first cryptographic information comprising a receiver identifier encrypted with a cryptographic key associated with the privacy routing system, the receiver identifier being associated with a second user, and transmitting a message from the device of the first user to the privacy routing system, the message comprising third cryptographic information and fourth cryptographic information, the third cryptographic information comprising the receiver identifier encrypted with the cryptographic key associated with the privacy routing system, the fourth cryptographic information having been determined based on the second cryptographic information. Optionally, the encrypted receiver identifier is re-randomized before being included in the message as (part of) the third cryptographic information.

The method further comprises decrypting, at the privacy routing system, the receiver identifier from the third cryptographic information with the cryptographic key or with a further cryptographic key corresponding to the cryptographic key, identifying, at the privacy routing system, the second user based on the decrypted receiver identifier, validating the fourth cryptographic information, and forwarding the message from the privacy routing system to a device of the second user based on a result of the validation of the fourth cryptographic information.

This method enables the privacy routing system or a device of the second user to create different encrypted receiver identifiers for different first users (i.e. for different senders; also referred to as Alices) using specific kinds of cryptosystems, for example randomizable cryptosystems. This prevents that third parties (including colluding Alices) are able to correlate messages addressed to the same recipient. However, the first user may (also) be able to re-randomize the encrypted receiver identifier, as some cryptosystems allow such re-randomization by the first user. Such re-randomization would help improve the privacy of the first user, as third parties cannot correlate messages originating from the same sender. However, this re-randomization makes it impossible for the privacy routing system to block messages/spam from certain senders based on the encrypted receiver identifier.

Since the receiver identifier is the same for all first users, the receiver identifier can also not be used to block messages/spam from certain first users. By transmitting second cryptographic information to the device of the first user, fourth cryptographic information received from the device of the first user, which was determined by the device of the first user based on the second cryptographic information, can be used to determine whether the message from the first user should be forwarded or not. This way, the second user may block spam without enabling third parties to correlate messages addressed to the same recipient.

Cryptographic information may comprise a cryptographic key, data encrypted with a cryptographic key, and/or other cryptographic information. The third cryptographic information may be the same as the first cryptographic information, but may alternatively be different, e.g. comprise a re-randomization of the received encrypted receiver identifier. If the third cryptographic information is different from the first cryptographic information, it should at least be derived from the first cryptographic information. Similarly, the fourth cryptographic information may be the same as the second cryptographic information, but may alternatively be different. The cryptographic key associated with the privacy routing system may be a public key, for example. The privacy routing system excludes the devices of the first and second users.

Validating the fourth cryptographic information may comprise decrypting the fourth cryptographic information or attempting to decrypt the fourth cryptographic information or may comprise validating the fourth cryptographic information in a different way, e.g. by verifying a revocation token comprised in the fourth cryptographic information.

In a second aspect of the invention, a first user device for use in the above-described method comprises at least one processor configured to receive first cryptographic information and second cryptographic information, the first cryptographic information comprising a receiver identifier encrypted with a cryptographic key associated with a privacy routing system, the receiver identifier being associated with a second user, include the receiver identifier encrypted with the cryptographic key associated with the privacy routing system in third cryptographic information, determine fourth cryptographic information based on the second cryptographic information, and transmit a message for a second user to the privacy routing system, the message comprising the third cryptographic information and the fourth cryptographic information.

The at least one processor of the first user device may be configured to determine the fourth cryptographic information by re-randomizing the second cryptographic information and/or to determine the third cryptographic information by re-randomizing the first cryptographic information. By having the first user device re-randomize the second cryptographic information before determining the fourth cryptographic information based on the second cryptographic information for each new message, it may be possible to prevent third parties from correlating different messages from the same first user. Preferably, the first user device then also re-randomizes the first cryptographic information before determining the third cryptographic information based on the first cryptographic information. Paillier encryption may be used, for example.

The second cryptographic information may comprise one or more predefined values encrypted with a sender-specific cryptographic information item associated with the second user and specific to the first user and the fourth cryptographic information may comprise the second cryptographic information or a randomization of the second cryptographic information. In this case, the one or more predefined values do not need to be known by the device of the first user. They only need to be known by the privacy routing system and the device of the second user. The one or more predefined values are used by the privacy routing system and/or the device of the second user to determine whether they are able to decrypt the fourth cryptographic information. The one or more pre-defined values may comprise a fixed value, such as “1”, or may be based on the rest of the message contents, e.g. as a check-sum, for example.

The sender-specific cryptographic information item is created by a device of the second user in relation to the first user. Sender-specific cryptographic information items associated with the second user are stored in one or more memories where a device or devices of the second user can access them. When the second user wants to block messages from the first user, a device of the second user marks the sender-specific cryptographic information item specific to the first user as a blocked sender-specific cryptographic information item and transmits it to the privacy routing system, which associates it with the second user. Thus, the privacy routing system only receives sender-specific cryptographic information items specific to blocked first users and is therefore not able to correlate messages from the same first user to the second user if that first user has not been blocked. The sender-specific cryptographic information item associated with the second user and specific to the first user may be a cryptographic key, for example.

Alternatively, the second cryptographic information may comprise a public key associated with the second user and specific to the first user and the fourth cryptographic information may comprise one or more predefined values encrypted with the public key, for example. In this case, the one or more predefined values are not only known by the privacy routing system and the device of the second user, but also by the device of the first user. The one or more predefined values may be known by other devices as well and may even be public. The one or more predefined values may be standardized, for example.

Furthermore, in this case, the public key and a corresponding private key are created by a device of the second user in relation to the first user. The private key is a type of sender-specific cryptographic item and may be handled in the same way as described above. Like the private keys, the corresponding public keys associated with the second user are also stored in one or more memories where a device or devices of the second user can access them.

In a third aspect of the invention, a second user device for use in the above-described method comprises at least one processor configured to transmit first cryptographic information and second cryptographic information to a device of a first user, the first cryptographic information comprising a receiver identifier encrypted with a cryptographic key associated with the privacy routing system, the receiver identifier being associated with a second user, and receive a message from the device of the first user via the privacy routing system. The first cryptographic information and second cryptographic information may form or be included in a “business card” that is provided to the first user, typically directly, e.g. presented as a scannable QR code or via NFC communication, but optionally via the privacy routing system.

The second cryptographic information may comprise a sender identifier encrypted with the cryptographic key or with a second cryptographic information key associated with the privacy routing system to allow the privacy routing system to drop messages based on the sender identifier. The receiver identifier and the sender identifier may be encrypted jointly in compound cryptographic information, a first part of the compound cryptographic information corresponding to the first cryptographic information and a second part of the compound cryptographic information corresponding to the second cryptographic information. Thus, only one encryption operation needs to be performed in relation to the receiver identifier and the sender identifier.

Alternatively, the message may comprise fourth cryptographic information which was determined based on the second cryptographic information and the at least one processor of the second user device may be configured to obtain one or more non-blocked-sender-specific cryptographic information items from a memory, attempt to decrypt the fourth cryptographic information with the one or more of non-blocked-sender-specific cryptographic information items, drop the message if the attempt to decrypt the fourth cryptographic information does not result in one or more pre-defined values and/or is not successful, and present the message to the user via a user interface if the attempt to decrypt the fourth cryptographic information results in the one or more pre-defined values.

This way, it becomes more difficult for the privacy routing system itself to make privacy-invading message correlations, as it does not handle any sender identifiers and only decrypts the one or more predefined values when transmitted by blocked senders (e.g. using blocked-sender-specific cryptographic information items received from the user device). As described above, the sender-specific cryptographic information items, e.g. keys, are normally created by a device of the second user and stored in one or more memories where a device or devices of the second user can access them.

As described above, the one or more (blocked-) sender-specific cryptographic information items are used by the privacy routing system and the device of the second user to determine whether they are able to decrypt the fourth cryptographic information. The one or more pre-defined values resulting from successful decryption may comprise a fixed value, such as “1”, or may be based on the rest of the message contents, e.g. as a check-sum, for example. The second user device, i.e. the device of the second user, also blocks/drops messages itself, as a blocked sender may transmit fourth cryptographic information which was not determined based on the second cryptographic information, which the privacy routing system would not be able to decrypt. Since the second user device has the non-blocked sender-specific cryptographic information items (which the privacy routing system does not), it can block/drop these messages from these malicious senders.

The message may further comprise a sender identifier encrypted with a cryptographic key associated with the second user, which is forwarded to the device of the second user by the privacy routing system. In this case, the device of the second user can first decrypt the sender identifier and then obtain only the non-blocked-sender-specific cryptographic information item associated with this sender identifier. If no non-blocked-sender-specific cryptographic information item is associated with this sender identifier, the message is dropped. If the message does not comprise an encrypted sender identifier, all non-blocked-sender-specific cryptographic information items may be obtained from the memory. The device of the second user can then attempt to decrypt the fourth cryptographic information with each of the non-blocked-sender-specific cryptographic information items, e.g. in sequence. The sender identifier is not encrypted with the public key of the privacy routing system to prevent the privacy routing system itself from making privacy-invading message correlations.

The at least one processor of the second user device may be configured to receive an encrypted receiver identifier from the privacy routing system, the receiver identifier being encrypted with a cryptographic key associated with the privacy routing system, and create the first cryptographic information by copying or re-randomizing the encrypted receiver identifier for the first user. By re-randomizing the encrypted receiver identifier, the same receiver identifier may be used for multiple senders/first users while still allowing different cryptographic information to be transmitted to the sender/first user, thereby preventing that third parties are able to make any privacy-invading message correlations.

The at least one processor of the second user device may be configured to transmit the first cryptographic information and the second cryptographic information to devices of a plurality of users, the plurality of users including the first user. This enables blocking of messages from a group as a whole and may save the second user time and effort. The group of users may share the same sender identifier and/or the same sender-specific cryptographic key, for example.

In a fourth aspect of the invention, a privacy routing system for routing messages comprises at least one processor configured to receive a message from a device of a first user, the message comprising third cryptographic information and fourth cryptographic information, the third cryptographic information comprising a receiver identifier encrypted with a cryptographic key associated with the privacy routing system, decrypt the receiver identifier from the third cryptographic information with the cryptographic key or with a further cryptographic key corresponding to the cryptographic key, identify a second user based on the decrypted receiver identifier, validate the fourth cryptographic information, and forward the message to a device of the second user based on a result of the validation of the fourth cryptographic information.

The at least one processor of the privacy routing system may be configured to receive a forwarding policy from a device of the second user and forward the message to a device of the second user further based on the forwarding policy. By allowing the second user to define a forwarding policy, the number of undesirable messages presented to the second user may be reduced as much as possible. Forwarding policies may include whitelisting, blacklisting, combinations thereof, time-based policies, or even more complex policies, for example. Examples of time-based forwarding policies include delivering messages from the second user's colleagues only between 9.00 and 18.00, exclusively delivering messages from the second user's close family members during sleeping hours, and temporarily forwarding all messages intended for the second user to someone else during the second user's vacation.

The fourth cryptographic information may comprise a sender identifier encrypted with the cryptographic key or with a second cryptographic item associated with the privacy routing system and the at least one processor of the privacy routing system may be configured to validate the fourth cryptographic information by decrypting the fourth cryptographic information with the cryptographic key, with the second cryptographic key, with the further cryptographic key, with another cryptographic key corresponding to the cryptographic key, or with a second further cryptographic key corresponding to the second cryptographic key, and forward the message to a device of the second user in dependence on whether the sender identifier is included in a list of sender identifiers. This typically makes it possible for the privacy routing system to block all messages from a certain sender, albeit with the drawback that the privacy routing system may be able to make privacy-invading message correlations itself. Sender identifiers may be blocked for only one user of the privacy routing system or for all users of the privacy routing system. The cryptographic key used to encrypt the sender identifier may be the same as or different from the cryptographic key used to encrypt the receiver identifier.

The fourth cryptographic information may comprise a revocation token generated by a device of the first user and the at least one processor of the privacy routing system may be configured to obtain a cryptographic accumulator, validate the fourth cryptographic information by verifying the revocation token with the cryptographic accumulator, and forward the message to a device of the second user in dependence on whether the revocation token was determined to be valid. By using a cryptographic accumulator, the contents of the white list and/or the black list may be kept secret.

The at least one processor of the privacy routing system may be configured to obtain, based on the decrypted receiver identifier, a plurality of blocked-sender-specific cryptographic information items from a memory, validate the fourth cryptographic information by attempting to decrypt the fourth cryptographic information with the plurality of blocked-sender-specific cryptographic information items, drop the message if the attempt to decrypt the fourth cryptographic information results in one or more pre-defined values and/or is successful, and forward the message to a device of the second user if the attempt to decrypt the fourth cryptographic information does not result in the one or more pre-defined values or is not successful.

This way, it becomes more difficult for the privacy routing system itself to make privacy-invading message correlations, as it does not process any sender identifiers, and is only able to decrypt the one or more pre-defined values transmitted by blocked senders. However, the device of the second user then typically also needs to block/drop messages itself, as a blocked sender may transmit fourth cryptographic information which was not determined based on the second cryptographic information, which the privacy routing system would not be able to decrypt and therefore forward. The one or more pre-defined values may comprise a fixed value, such as “1”, or may be based on the rest of the message contents, e.g. as a check-sum, for example. If the one or more pre-defined values are determined based on the message contents, this verification at the device of the second user may replace traditional message verification procedures, e.g. regular checksum-based message integrity checks.

The at least one processor of the privacy routing system may be configured to generate the receiver identifier, e.g. to ensure that each receiver identifier is unique on the privacy routing system (which excludes the device of the first user and the device of the second user). The privacy routing system may encrypt the receiver identifier itself or let the device of the second user encrypt the receiver identifier, e.g. depending whether the complexity of the user device or the complexity of the privacy routing system should be minimized. If the privacy routing system encrypts the receiver identifier, the device of the second user re-randomizes the encrypted receiver identifier.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

In a fifth aspect of the invention, a computer program product comprises instructions which, when the program is executed by a privacy routing system, cause the privacy routing system to perform the steps of receiving a message from a device of a first user, the message comprising third cryptographic information and fourth cryptographic information, the third cryptographic information comprising a receiver identifier encrypted with the cryptographic key associated with the privacy routing system, decrypting the receiver identifier from the third cryptographic information with the cryptographic key or with a further cryptographic key corresponding to the cryptographic key, identifying a second user based on the decrypted receiver identifier, validating the fourth cryptographic information, and forwarding the message to a device of the second user based on a result of the validation of the fourth cryptographic information. The computer program product may be stored on a non-transitory computer-readable storage medium.

In a sixth aspect of the invention, a computer program product comprises instructions which, when the program is executed by a first user device, cause the first user device to perform the steps of receiving first cryptographic information and second cryptographic information, the first cryptographic information comprising a receiver identifier encrypted with a cryptographic key associated with a privacy routing system, the receiver identifier being associated with a second user, including the receiver identifier encrypted with the cryptographic key associated with the privacy routing system in third cryptographic information, determining fourth cryptographic information based on the second cryptographic information, and transmitting a message for a second user to the privacy routing system, the message comprising the third cryptographic information and the fourth cryptographic information. The computer program product may be stored on a non-transitory computer-readable storage medium.

In a seventh aspect of the invention, a computer program product comprises instructions which, when the program is executed by a second user device, cause the second user device to perform the steps of transmitting first cryptographic information and second cryptographic information to a device of a first user, the first cryptographic information comprising a receiver identifier encrypted with a cryptographic key associated with the privacy routing system, the receiver identifier being associated with a second user, and receiving a message from the device of the first user via the privacy routing system. The computer program product may be stored on a non-transitory computer-readable storage medium.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method of routing messages via a privacy routing system;

FIG. 2 is a flow diagram of a second embodiment of the method of routing messages via a privacy routing system;

FIG. 3 is a flow diagram of a first part of a third embodiment of the method of routing messages via a privacy routing system;

FIG. 4 is a flow diagram of a second part of the third embodiment of the method of routing messages via a privacy routing system;

FIG. 5 is a flow diagram of a first part of a fourth embodiment of the method of routing messages via a privacy routing system;

FIG. 6 is a flow diagram of a second part of the fourth embodiment of the method of routing messages via a privacy routing system;

FIG. 7 is a flow diagram of a third part of a fourth embodiment of the method of routing messages via a privacy routing system;

FIG. 8 is a flow diagram of a fourth part of the fourth embodiment of the method of routing messages via a privacy routing system;

FIG. 9 is a flow diagram of a fifth part of the fourth embodiment of the method of routing messages via a privacy routing system;

FIG. 10 is a block diagram of an embodiment of a messaging system which comprises embodiments of the privacy routing system and the first and second user devices; and

FIG. 11 is a block diagram of an exemplary data processing system for performing the steps of the method of the invention.

Corresponding elements in the drawings are denoted by the same reference numeral.

### DETAILED DESCRIPTION OF THE DRAWINGS

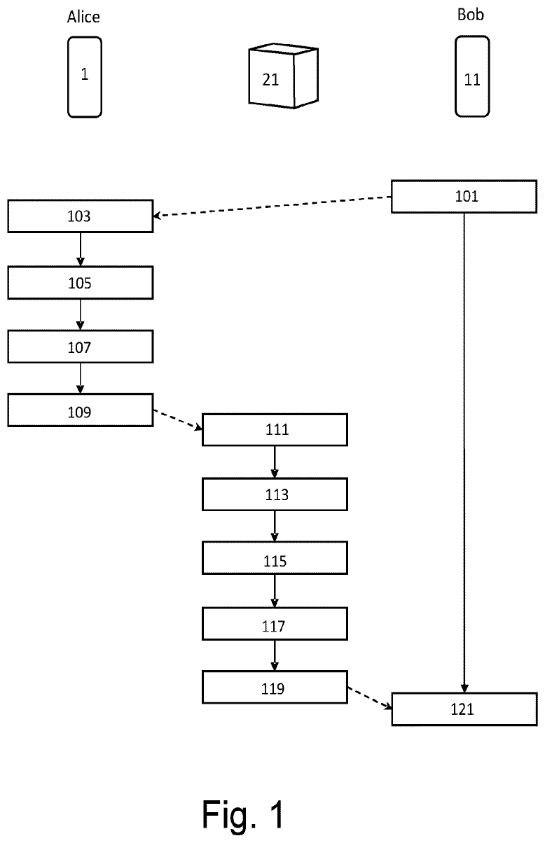

A first embodiment of the method of routing messages via a privacy routing system 21 is shown in FIG. 1. A step 101 comprises a device 11 of a second user (also referred to as Bob) transmitting first cryptographic information and second cryptographic information to a device 1 of a first user (also referred to as Alice). The first cryptographic information comprises a receiver identifier encrypted with a cryptographic key associated with the privacy routing system. The receiver identifier is associated with the second user.

The receiver identifier may be received from the privacy routing system before step 101 is performed (not shown in FIG. 1). The received receiver identifier may already be encrypted with a cryptographic key associated with the privacy routing system 21. In this case, the first cryptographic information may be created by re-randomizing the received encrypted receiver identifier for the first user. Alternatively, the device 11 may itself encrypt the received receiver identifier with a cryptographic key associated with the privacy routing system.

The receiver identifier may be the second user's e-mail address, for example. Alternatively, if the privacy routing system 21 is part of a mobile communication network, e.g. a 4G or 5G network, the receiver identifier for the second user may be the second user's MS-ISDN number, the IMEI of a/the device of the second user, or an identifier that is derived from the SIM key hierarchy on a/the device of the second user, for example. Combinations of these identifiers may alternatively be used as receiver identifier. Alternatively or additionally, other identifiers may be used as receiver identifier.

The cryptographic key may be a symmetric key or an asymmetric key. If the cryptographic key is an asymmetric key, it may be a public key and the receiver identifier encrypted with the cryptographic key, i.e. public key, may then be decrypted with the corresponding further cryptographic key, i.e. a private key. For instance, one or more of the following public-key cryptography systems may be used: El Gamal, RSA, Paillier. The used public-key cryptography system(s) may be based on cyclic modulo groups, elliptic curve groups or other cyclic groups. Re-randomization properties of such public key cryptosystems may be used to randomize encrypted identifiers, so messages transmitted using the same encrypted identifier cannot be correlated. The Cramer-Shoup double-strand encryption scheme may be used in order to offer re-randomization without malleability.

A widely known key agreement protocol (such as Diffie-Helman) may be used to ensure that the device 11 of the second user is in possession of the cryptographic key associated with the privacy routing system 21. Alternatively, the cryptographic key may be provisioned in the device 11 such that it is not necessary to transfer a cryptographic key, e.g. a symmetric key, from the privacy routing system 21 to the device 11. If the privacy routing system 21 is part of a mobile communication network, the cryptographic key may be provided to the device 11 via a SIM card.

If the privacy routing system 21 is part of a mobile communication network, one of the mobile communication network's listed encryption algorithms for symmetric keys may be used, such as GEA4, GEA5, UEA1, UEA2 (TS 35.215), EEA1, EEA2, EEA3 (TS 33.401), NEA1, NEA2, NEA3 (TS 33.501). Example underlying algorithms are SNOW 3G, AES, ZUC, SNOW V.

Cryptographic information may comprise a cryptographic key, data encrypted with a cryptographic key, and/or other cryptographic information. The first cryptographic information and the second cryptographic information may be transmitted to devices of a plurality of users, i.e. to device 1 and to devices of others users. This enables blocking of messages from a group as a whole and may save the second user time and effort. The group of users may share the same sender identifier and/or the same sender-specific cryptographic key, for example. In an alternative embodiment, step 101 is performed by or via the privacy routing system 21. In a further alternative embodiment, the first and second cryptographic information are shared through means other than transmission.

The information transmitted by device 11 to device 1 in step 101 may also comprise an identifier of the privacy routing system 21 so that device 11 (and optionally other devices of the first user) knows that messages for the second user should be routed via privacy routing system 21. This information may have been previously received by device 11 from the privacy routing system 21.

A step 103 comprises device 1 receiving the first cryptographic information and the second cryptographic information. Step 105 comprises the device 1 including the receiver identifier, encrypted with the cryptographic key associated with the privacy routing system, in third cryptographic information. A step 107 comprises determining fourth cryptographic information based on the second cryptographic information. A step 109 comprises transmitting a message from the device 1 of the first user to the privacy routing system 21. The message comprises the third cryptographic information determined in step 105 and the fourth cryptographic information determined in step 107.

The third cryptographic information may be the same as the first cryptographic information, but may alternatively be different, e.g. comprise a re-randomization of the received encrypted receiver identifier. If the third cryptographic information is different from the first cryptographic information, it should at least be derived from the first cryptographic information. Similarly, the fourth cryptographic information may be the same as the second cryptographic information, but may alternatively be different. Step 107 may comprise determining the fourth cryptographic information by re-randomizing the second cryptographic information, for example.

The body of the message may be encrypted using end-to-end encryption to ensure that the body of the message remains private to the first and second users and/or digitally signed to give the second user the assurance that there is no man-in-the-middle. This digital signing should give the second user assurance that the second user is communicating with the same first user, but the second user does not need to be able to identify that first user. Encrypted and/or authenticated communication may also be used between device 1 and privacy routing system 21 and between device 11 and privacy routing system 21. Information on which technologies should be used for encryption and authentication may be provided to devices 1 and 11 by the privacy routing system 21.

A step 111 comprises the privacy routing system 21 receiving the message from the device 1 of the first user. A step 113 comprises the privacy routing system 21 decrypting the receiver identifier from the third cryptographic information with the cryptographic key or with a further cryptographic key corresponding to the cryptographic key. If the cryptographic key is a symmetric key, the receiver identifier is decrypted with the cryptographic key. If the cryptographic key is an asymmetric key, the cryptographic key may be a public key and the receiver identifier is then decrypted with the corresponding private key.

A step 115 comprises the privacy routing system 21 identifying the second user based on the receiver identifier decrypted in step 113. Step 115 may comprise determining a current address of the second user. A step 117 comprises the privacy routing system 21 validating the fourth cryptographic information. In an alternative embodiment, the privacy routing system 21 requests the device 11 of the second user to validate the fourth cryptographic information and in response receives information indicating the result of the validation of the fourth cryptographic information from the device 11.

A step 119 comprises the privacy routing system 21 forwarding the message from the privacy routing system 21 to the device 11 of the second user based on a result of the validation of the fourth cryptographic information of step 117. A step 121 comprises the device 11 of the second user receiving the message from the device 1 of the first user via the privacy routing system 21. In the embodiment of FIG. 1, the message (i.e. at least the body thereof) is forwarded in step 119 to the same device of the second user which transmitted the first and second cryptographic information in step 101. In an alternative embodiment, the message may be forwarded to another device of the second user in step 119.

Normally, the device 11 of the second user performs step 101 at least once for each first user with which the second user wants to communicate and performs step 121 for each message not dropped by the privacy routing system 21. Normally, the device 1 of the first user performs step 103 at least once for each second user that wishes to communicate with the first user and performs step 109 for each message that the first user wants to send. The device 1 of the first user performs steps 105 and 107 at least once after each performance of step 103 and may perform steps 105 and 107 before each performance of step 109 (to perform re-randomization) to provide even further unlinkability. The privacy routing system 21 performs steps 111-119 for each message transmitted by a first user.

The devices 1 and 11 in the method of FIG. 1 may also switch roles, i.e. the device 1 may be able to perform steps 101 and 121 and the device 11 may be able to perform steps 103-109 to allow the second user to send messages to the first user.

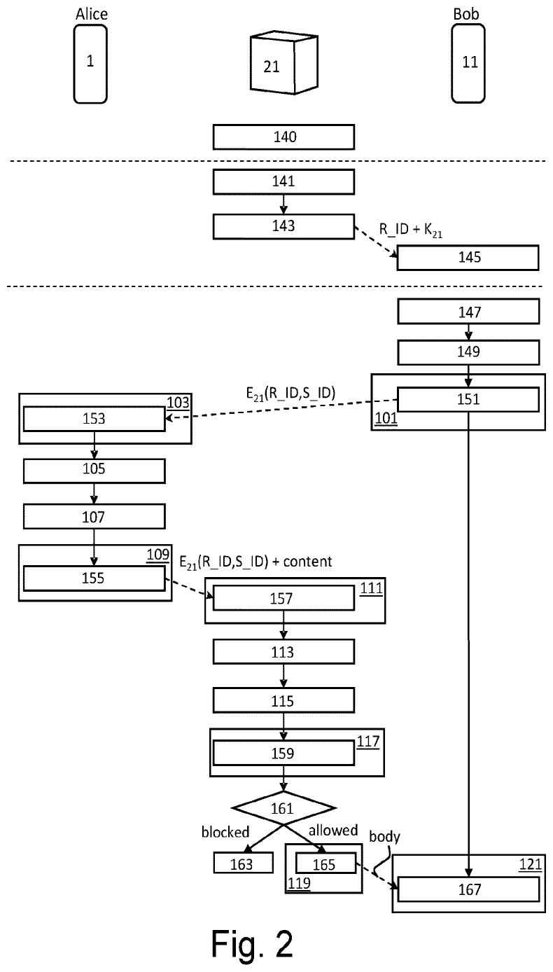

A second embodiment of the method of routing messages via a privacy routing system is shown in FIG. 2. The steps of the method of FIG. 2 are performed by embodiments of the privacy routing system 21 and the first and second user devices 1 and 11, as described in relation to FIG. 1.

A step 140 comprises the privacy routing system 21 generating the cryptographic key K₂₁ associated with the privacy routing system (e.g. a symmetric key or a public key) and optionally the further cryptographic key corresponding to the cryptographic key (e.g. the private key corresponding to the afore-mentioned public key). Since the cryptographic key is not specific to the second user (or the first user), step 140 only needs to be performed once, although it might be done again in the case of key renewal (a.k.a. key rotation).

A step 141 comprises the privacy routing system 21 generating a receiver identifier R_ID for the second user. Step 141 is typically performed when an account is created for the second user in the privacy routing system. Each generated receiver identifier is unique on the privacy routing system 21. A step 143 comprises the privacy routing system 21 transmitting the receiver identifier R_ID, either encrypted with cryptographic key K₂₁ or unencrypted, to the device 11 of the second user. In the embodiment of FIG. 2, the cryptographic key K₂₁ itself is also transmitted in step 143. In an alternative embodiment, the privacy routing system 21 shares the cryptographic key K₂₁ in a different manner. A step 145 comprises the device 11 of the second user receiving the receiver identifier R_ID and the cryptographic key K₂₁. Steps 141-145 are normally performed for each receiver/user of the privacy routing system 21.

A step 147 comprises the device 11 of the second user generating a sender identifier S_ID for the first user. This sender identifier S_ID is unique for the first user specific to the second user, but the first user does not need to know the sender identifier S_ID. In an alternative embodiment, the sender identifier S_ID is generated by the privacy routing system 21. The device 11 of the second user may be able to generate a new sender identifier for the first user and a new associated forwarding policy whenever desired, e.g., when establishing a new communication relationship with the first user for a different persona.

Optionally, after the device 11 has performed step 147, the device 11 may transmit an (updated) forwarding policy to the privacy routing system 21. By allowing the second user to define a forwarding policy, the number of undesirable messages presented to the second user may be reduced as much as possible. For example, the second user (Bob) may be able to update his forwarding policy with the privacy routing system and make the privacy routing system block messages from the first user (Alice). The second user could perform this action, for example when second user's business dealings with the first user have terminated, when the first user would start spamming the second, when the second user finds out that the first user has shared the encrypted combination with unauthorized third parties, or for another reason.

Forwarding policies may include whitelisting, blacklisting, combinations thereof, time-based policies, or even more complex policies, for example. An example of a more complex policy is “this sender identifier is default whitelisted”, or “forward only messages from a sender identifier from this group only if it is the very first message, or if the message is within two weeks from forwarding that first message for that sender identifier”. Examples of time-based forwarding policies include delivering messages from the second user's colleagues only between 9.00 and 18.00, exclusively delivering messages from the second user's close family members during sleeping hours, and temporarily forwarding all the second user's messages to someone else during the second user's vacation.

The protocol that the second device uses for configuring its forwarding policies and/or sender identifiers may be HTTP, HTTPS, RADIUS, DIAMETER, SIP, DHCP, or DIDcomm, for example. The conveyed data in those configuration messages may be encoded using XML, JSON, JSON-LD, JWT, JWE, SDP, binary, text, or ASNI, for example.

A step 149 comprises encrypting the sender identifier with the cryptographic key K₂₁ received in step 145. If the receiver identifier R_ID received in step 145 was not received in encrypted form, the receiver identifier R_ID is also encrypted with the cryptographic key K₂₁. The receiver identifier and the sender identifier may then be encrypted jointly in compound cryptographic information. In an alternative embodiment, the receiver identifier R_ID and the sender identifier S_ID are encrypted with different cryptographic keys associated with the privacy routing system 21. The device 11 of the second user may perform steps 149 and 151 once per first user or, to provide even further unlinkability, multiple times per first user.

In the embodiment of FIG. 2, step 101 of FIG. 1 is implemented by a step 151. Step 151 comprises the device 11 of the second user transmitting the first cryptographic information and second cryptographic information to the device 1 of the first user, preferably directly but optionally via the privacy routing system 21. Like in the embodiment of FIG. 1, the first cryptographic information comprises the encrypted receiver identifier R_ID. In the embodiment of FIG. 2, the second cryptographic information comprises the encrypted sender identifier S_ID. If the receiver identifier and the sender identifier were encrypted jointly in step 149, the compound cryptographic information is transmitted in step 151. A first part of the compound cryptographic information corresponds to the first cryptographic information and a second part of the compound cryptographic information corresponds to the second cryptographic information.

In the embodiment of FIG. 2, step 103 of FIG. 1 is implemented by a step 153 and step 109 of FIG. 1 is implemented by a step 155. Step 153 comprises device 1 receiving the first cryptographic information and the second cryptographic information. In the embodiment of FIG. 2, the second cryptographic information comprises the encrypted sender identifier S_ID. Step 105 comprises the device 1 including the receiver identifier, encrypted with the cryptographic key associated with the privacy routing system, in third cryptographic information. Step 107 comprises determining fourth cryptographic information based on the second cryptographic information. Step 155 comprises transmitting a message from the device 1 of the first user to the privacy routing system 21. The message comprises the third cryptographic information determined in step 105 and the fourth cryptographic information determined in step 107. In the embodiment of FIG. 2, the fourth cryptographic information comprises the encrypted sender identifier S_ID.

In the embodiment of FIG. 2, step 111 of FIG. 1 is implemented by a step 157. Step 157 comprises the privacy routing system 21 receiving the message from the device 1 of the first user. Step 113 comprises the privacy routing system 21 decrypting the receiver identifier R_ID from the third cryptographic information with the cryptographic key or with the further cryptographic key corresponding to the cryptographic key. Step 115 comprises the privacy routing system 21 identifying the second user based on the receiver identifier decrypted in step 113.

In the embodiment of FIG. 2, step 117 of FIG. 1 is implemented by a step 159. Step 159 comprises the privacy routing system 21 decrypting the fourth cryptographic information with the cryptographic key or with the further cryptographic key. In the above-mentioned alternative embodiment in which the sender identifier was encrypted with a second cryptographic key associated with the privacy routing system, step 159 comprises the privacy routing system 21 decrypting the fourth cryptographic information with the second cryptographic key or with a second further cryptographic key corresponding to the second cryptographic key.

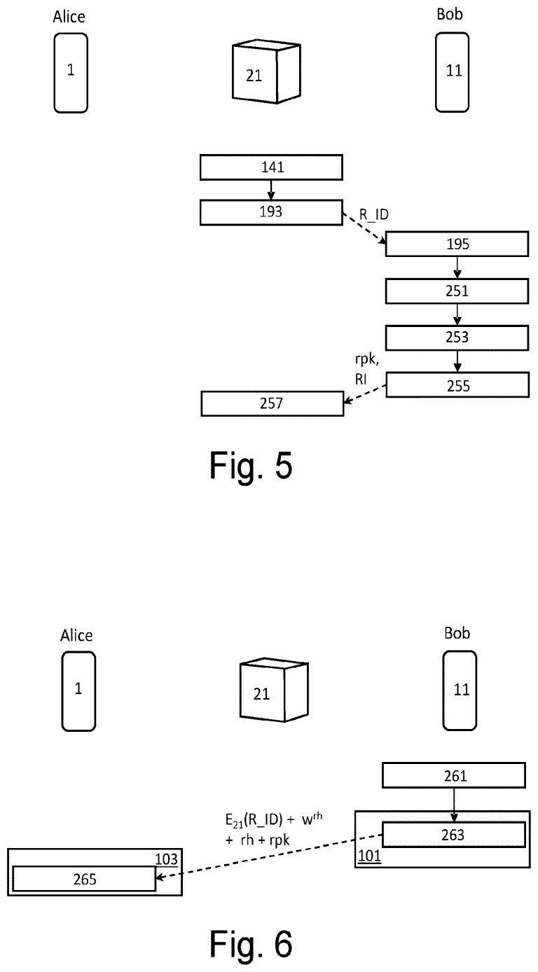

A step 161 comprises checking whether the sender identifier S_ID decrypted in step 159 is included in a list of sender identifiers. This list of sender identifiers may be part of a received forwarding policy or may be determined based on a received forwarding policy, for example. The list of sender identifiers may be a list of blocked sender identifiers or a list of allowed (non-blocked) sender identifiers. Zero-knowledge set membership proofs or cryptographic accumulators may be used to realize anonymous pass-lists or block-lists based on the sender identifiers, as will described in relation to FIGS. 5 to 9.

In the embodiment of FIG. 2, a list of sender identifiers associated with the receiver identifier decrypted in step 113 is obtained. Thus, the list of sender identifiers is specific to the second user. In an alternative embodiment, alternatively or additionally, a list of sender identifiers is used that applies to all users of the privacy routing system 21. In this alternative embodiment, the sender identifier S_ID may be generated by the privacy routing system 21 (such that each generated sender identifier is unique on the privacy routing system) instead of by the device 11 of the second user, as described in relation to step 147.

A step 163 is performed if it is determined in step 161 that the first user is blocked. Step 163 comprises dropping the message. Step 119 is performed if it is determined in step 161 that the first user is allowed (i.e. not blocked). In the embodiment of FIG. 2, step 119 is implemented by a step 165. Step 165 comprises the privacy routing system 21 forwarding the message from the privacy routing system 21 to the device 11 of the second user. If the privacy routing system 21 received a forwarding policy from the device 11 of the second user, the privacy routing system 21 may forward the message to the device 11 of the second user further based on the forwarding policy.

Step 121 comprises the device 11 of the second user receiving the message from the device 1 of the first user via the privacy routing system 21. In the embodiment of FIG. 2, step 121 is implemented by a step 167. In step 167, only the body of the message is forwarded; the receiver identifier R_ID and the sender identifier S_ID are not forwarded. In an alternative embodiment, the sender identifier S_ID may be forwarded in addition to the body of the message.

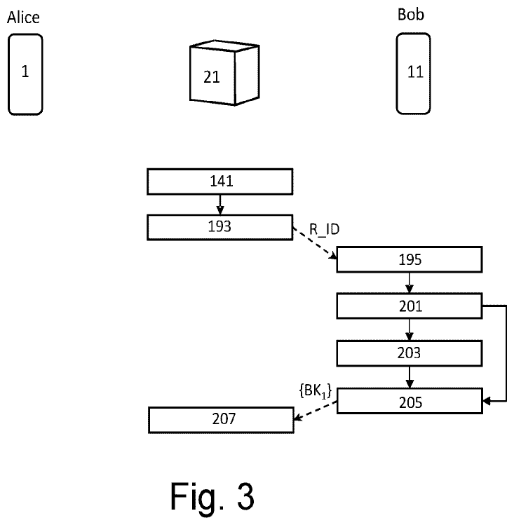

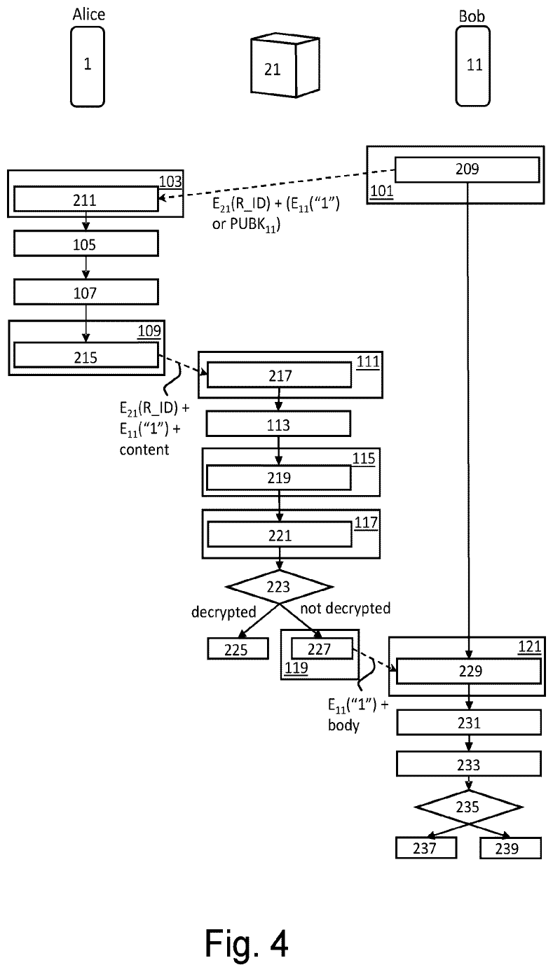

A third embodiment of the method of routing messages via a privacy routing system is shown in FIGS. 3 and 4. The steps of the method of FIGS. 3 and 4 are performed by embodiments of the privacy routing system 21 and the first and second user devices 1 and 11, as described in relation to FIG. 1.

Step 141 of FIG. 3 comprises the privacy routing system 21 generating a receiver identifier R_ID for the second user. Step 141 is typically performed when an account is created for the second user in the privacy routing system. Each generated receiver identifier is unique on the privacy routing system. A step 193 comprises the privacy routing system 21 transmitting the receiver identifier R_ID, either encrypted with cryptographic key K₂₁ or unencrypted, to the device 11 of the second user. A step 195 comprises the device 11 of the second user receiving the receiver identifier R_ID.

A step 201 comprises the device 11 of the second user creating sender-specific cryptographic information items for each sender/first user with which the second user wishes to communicate and storing them in a memory. The sender-specific cryptographic information items may comprise a private key and a corresponding public key for each sender, for example. In the embodiment of FIG. 3, each sender is considered allowed/non-blocked until it is blocked in a step 203. In FIG. 3, step 203 is shown as being optionally performed directly after step 201, but typically, step 203 may be performed at any time after step 201. It may be possible to unblock sender-specific cryptographic information items. Alternatively, a new sender-specific cryptographic information item may be created for the same first user.

A step 205 comprises the device 11 of the second user transmitting the blocked sender-specific cryptographic information items, i.e. the cryptographic information items associated with blocked senders/first users, to the privacy routing system 21. A step 207 comprises the privacy routing system 21 receiving the blocked sender-specific cryptographic information items and storing them in a memory associated with the receiver identifier R_ID of the second user. Thus, the privacy routing system only receives sender-specific cryptographic information items specific to blocked users and is therefore not able to correlate messages from the same sender if the sender has not been blocked. Steps 201-207 may be performed multiple times at different moments.

The method then continues in FIG. 4. In the embodiment of FIGS. 3 and 4, step 101 of FIG. 1 is implemented by a step 209, shown in FIG. 4. Step 209 comprises the device 11 of the second user transmitting the first cryptographic information and second cryptographic information to the device 1 of the first user. Like in the embodiment of FIG. 1, the first cryptographic information comprises the encrypted receiver identifier R_ID. In the embodiment of FIGS. 3 and 4, the second cryptographic information comprises one or more predefined values encrypted with a sender-specific cryptographic key associated with the second user and specific to the first user, e.g. a public key PUBK₁₁, or comprises a public key associated with the second user and specific to the first user, e.g. public key PUBK₁₁.

The one or more pre-defined values may comprise a fixed value, such as “1”, or may be based on the rest of the message contents, e.g. as a check-sum, for example. In a variant on the embodiment of FIGS. 3 and 4, the second cryptographic information comprises different cryptographic information. The device 11 of the second user needs to ensure that the device 1 of the first user is able to transmit the one or more pre-defined values encrypted and randomized. This can be realized in various ways. In addition to the two ways described above, a third way comprises the device 11 transmitting encrypted predefined value(s) E and a randomization factor R to the device 1, after which the device 1 is able to randomize the encrypted pre-defined value(s) by calculating E*R\hat{ }n for a random value of n, optionally in a finite field specified by the device 11 of the second user or the privacy routing system 21.

This third way is based on the Paillier encryption scheme.

In the embodiment of FIGS. 3 and 4, step 103 of FIG. 1 is implemented by a step 211 and step 109 of FIG. 1 is implemented by a step 215. Step 211 comprises device 1 receiving the first cryptographic information and the second cryptographic information. Step 105 comprises the device 1 including the receiver identifier, encrypted with the cryptographic key associated with the privacy routing system, in third cryptographic information.

Step 107 comprises determining fourth cryptographic information based on the second cryptographic information. The fourth cryptographic information may be the same as the second cryptographic information, but may alternatively be different. Step 107 may comprise determining the fourth cryptographic information by re-randomizing the second cryptographic information, for example. Alternatively, step 107 may comprise determining the fourth cryptographic information by encrypting one or more predefined values, e.g. “1”, with the public key PUBK₁₁ received as or as part of second cryptographic information in step 211, for example.

Step 215 comprises transmitting a message from the device 1 of the first user to the privacy routing system 21. The message comprises the third cryptographic information determined in step 105 and the fourth cryptographic information determined in step 107. In the embodiment of FIGS. 3 and 4, the fourth cryptographic information comprises one or more predefined values encrypted with the public key PUBK₁₁, e.g. the encrypted one or more predefined values received in step 211, a re-randomization of the encrypted one or more predefined values received in step 211, or one or more predefined values encrypted by the device 1 itself in step 107 with the public key PUBK₁₁ received in step 103.

In the embodiment of FIGS. 3 and 4, step 111 of FIG. 1 is implemented by a step 217. Step 217 comprises the privacy routing system 21 receiving the message from the device 1 of the first user. Step 113 comprises the privacy routing system 21 decrypting the receiver identifier R_ID from the third cryptographic information with the cryptographic key or with the further cryptographic key corresponding to the cryptographic key. Step 115 comprises the privacy routing system 21 identifying the second user based on the receiver identifier decrypted in step 113. In the embodiment of FIGS. 3 and 4, step 115 comprises a sub step 219. Step 219 comprising obtaining, based on the receiver identifier decrypted in step 113, the plurality of blocked-sender-specific cryptographic information items received in step 207 from the memory.

In the embodiment of FIGS. 3 and 4, step 117 of FIG. 1 is implemented by a step 221. Step 221 comprises attempting to decrypt the fourth cryptographic information with the plurality of blocked-sender-specific cryptographic information items to obtain the one or more pre-defined values. The one or more predefined values are used by the privacy routing system 21 and the device 11 of the second user to determine whether they are able to decrypt the fourth cryptographic information. The one or more predefined values may be standardized, for example.

A step 223 comprises determining if the attempt to decrypt the fourth cryptographic information results in the one or more pre-defined values. A step 225 is performed if it is determined in step 223 that the attempt to decrypt the fourth cryptographic information results in the one or more pre-defined values. Step 225 comprises dropping the message. Step 119 is performed if it is determined in step 223 that the attempt to decrypt the fourth cryptographic information does not result in the one or more pre-defined values.

In an alternative embodiment, step 223 comprises determining whether the attempt to decrypt the fourth cryptographic information was successful, step 225 is performed if it is determined in step 223 that the attempt to decrypt the fourth cryptographic information was successful and step 119 is performed if it is determined in step 223 that the attempt to decrypt the fourth cryptographic information was not successful. This alternative embodiment is beneficial when the cryptographic method indicates the success of the decryption, but not all cryptographic methods do this.

In the embodiment of FIGS. 3 and 4, step 119 is implemented by a step 227. Step 227 comprises the privacy routing system 21 forwarding the message from the privacy routing system 21 to the device 11 of the second user. The forwarded message comprises the fourth cryptographic information, i.e. one or more predefined values encrypted with the public key PUBK₁₁, in addition to the body of the message. In the embodiment of FIGS. 3 and 4, step 121 of FIG. 1 is implemented by a step 229. Step 229 comprises the device 11 of the second user receiving the message, i.e. the body of the message and the one or more predefined values encrypted with the public key PUBK₁₁.

A step 231 comprises the device 11 of the second user obtaining one or more non-blocked-sender-specific cryptographic information items from the memory in which they were stored in step 201. In the embodiment of FIGS. 3 and 4, the sender-specific cryptographic information items which were not marked as blocked in step 203 are obtained in step 231. A step 233 comprises the device 11 of the second user attempting to decrypt the fourth cryptographic information with the one or more non-blocked-sender-specific cryptographic information items obtained in step 231 to obtain the one or more predefined values, e.g. “1” or a check-sum value based on the message contents. In the embodiment of FIGS. 3 and 4, all non-blocked-sender-specific cryptographic information items are obtained from the memory. The device 11 of the second user then attempts to decrypt the fourth cryptographic information with each of the non-blocked-sender-specific cryptographic information items, e.g. in sequence.

A step 235 comprises determining if the attempt to decrypt the fourth cryptographic information results in the one or more pre-defined values. A step 237 is performed if it is determined in step 235 that the attempt to decrypt the fourth cryptographic information does not result in the one or more pre-defined values. Step 237 comprises the device 11 of the second user dropping the message. A step 239 is performed if it is determined in step 223 that the attempt to decrypt the fourth cryptographic information results in the one or more pre-defined values. Step 239 comprises the device 11 of the second user presenting the (body of the) message to the user via a user interface.

In the alternative embodiment described above, step 235 comprises determining whether the attempt to decrypt the fourth cryptographic information was successful, step 237 is performed if it is determined in step 235 that the attempt to decrypt the fourth cryptographic information was not successful, and step 239 is performed if it is determined in step 235 that the attempt to decrypt the fourth cryptographic information was successful.

Thus, the device 11 of the second user also blocks/drops messages itself, as a blocked sender may transmit fourth cryptographic information which was not determined based on the second cryptographic information, which the privacy routing system would not be able to decrypt. Alternatively, if a check-sum value is used as the predefined value, a message that has been corrupted in transit will have an incorrect check-sum value. Since the second user device has the non-blocked sender-specific cryptographic information items (which the privacy routing system does not), it can block/drop these malicious or corrupted messages. In another embodiment, steps 235 and 237 are omitted and step 239 is performed even if decrypting the fourth cryptographic information does/would not result in the one or more pre-defined values. However, this may mean that some of the messages presented to the user may be malicious or corrupted messages.

In the embodiment of FIGS. 3 and 4, the device 11 of the second user does not transmit a sender identifier to the device 1 of the first user and the message transmitted by device 1 of the first user in step 215 therefore does not comprise a sender identifier either. In an alternative embodiment, the device 11 of the second user transmits a sender identifier encrypted with a cryptographic key associated with the second user to device 1 of the second user, for instance as part of the message body. In this alternative embodiment, the message transmitted by device 1 of the first user in step 215 also comprises this encrypted sender identifier and this encrypted sender identifier is also forwarded in step 227 to the device 11.

In this alternative embodiment, the device 11 of the second user can first decrypt the sender identifier and then obtain only the non-blocked-sender-specific cryptographic information item associated with this sender identifier. If no non-blocked-sender-specific cryptographic information item is associated with this sender identifier, the message is dropped. The sender identifier is not encrypted with the public key of the privacy routing system 21 to prevent the privacy routing system 21 itself from making privacy-invading message correlations.

A fourth embodiment of the method of routing messages via a privacy routing system is shown in FIGS. 5 to 9. The steps of the method of FIGS. 5 to 9 are performed by embodiments of the privacy routing system 21 and the first and second user devices 1 and 11, as described in relation to FIG. 1. In this fourth embodiment, a cryptographic accumulator is used. This cryptographic accumulator may be based on asymmetric accumulators: Merkle trees, bi-linear map constructions and modular exponentiation (RSA accumulator), or on symmetric accumulators: Bloom filter, Cuckoo filter.

Specifically, in this fourth embodiment, an Anonymous Revocation Component (ARC) is used, together with a Join algorithm, based on a negative dynamic cryptographic accumulator (ACCN) to allow the second user to put the first user on (and also off again, if desired) a blacklist. Moreover, it allows the first user to prove anonymously with a zero-knowledge proof (ZKP) to the privacy routing system 21 that the first user is not on the second user's blacklist. ARC with Join based on ACCN is described in the paper “Accumulators with Applications to Anonymity-Preserving Revocation” by Baldimtsi, Camenisch, Dubovitskaya, Lysyanskaya, Reyzin, Samelin, Yakoubov, published in IEEE

### European Symposium on Security and Privacy 2017.

The system described in this paper requires a revocation authority (RA) which assists issuers in adding new users to the system, maintains the necessary revocation information (RI), and changes the revocation status of users in the system. In this fourth embodiment of FIGS. 5 to 9, these RA functionalities are split over the device 11 and the privacy routing system 21. Revocation in the ARC is done via a special value: a revocation handle (rh). A revocation handle may be embedded into the revocable object (e.g. the message the first user wants to send to the second user via the privacy routing system 21). The rh is bound to the revocable object with a signature.

FIG. 5 shows a new second user being added to the privacy routing system 21. Step 141 of FIG. 5 comprises the privacy routing system 21 generating a receiver identifier R_ID for the second user. Each generated receiver identifier is unique on the privacy routing system. Step 193 comprises the privacy routing system 21 transmitting the receiver identifier R_ID, either encrypted with cryptographic key K₂₁ or unencrypted, to the device 11 of the second user. Step 195 comprises the device 11 of the second user receiving the receiver identifier R_ID.

A step 251 comprises the device 11 of the second user running the SPGen algorithm described in the above-mentioned paper “Accumulators with Applications to Anonymity-Preserving Revocation”. The SPGen algorithm has the following input and output:

```
a. Input:
  i. global system parameters spar_{g} (group descriptions, parameters for
  ZKP, etc.)
b. Output:
  i. the revocation system parameters sparᵣ = (spar_{g}, RS), where RS
  specifies the set of supported revocation handles.
```

A step 253 comprises the device 11 of the second user running the RKGen algorithm described in the above-mentioned paper “Accumulators with Applications to Anonymity-Preserving Revocation”. The RKGen algorithm has the following input and output:

```
a. Input:
  i. revocation system parameters (sparᵣ)
b. Output:
  i. the revocation public key (rpk),
  ii. the revocation secret key (rsk) = (
  1. signing key (sgk),
  2. secret key (sk),
  3. auxiliary information for maintenance of the accumulator (m)
  ),
  iii. and the revocation information (RI) = (
  1. the accumulator value (a),
  2. the list of all update messages (M),
  3. a signature on the RI (σ),
  )
```

A step 255 comprises the device 11 of the second user transmitting the rpk and RI obtained in step 253 to the privacy routing system 21. A step 257 comprises the privacy routing system 21 receiving the rpk and RI and storing them in a memory associated with the receiver identifier R_ID of the second user. In the embodiment of FIGS. 5 to 9, the SPGen algorithm is run by the device 11 of the second user. In an alternative embodiment, the SPGen algorithm is run by the privacy routing system 21, which then transmits sparr to the device 11 of the second user.

FIG. 6 shows a new first user being enabled to communicate with the second user after the method of FIG. 5 has been performed. A step 261 comprises the device 11 of the second user running the Join algorithm described in the above-mentioned paper “Accumulators with Applications to Anonymity-Preserving Revocation”. The Join algorithm has the following input and output:

```
a. Input:
  i. revocation secret key (rsk)
  ii. the revocation public key (rpk)
  iii. the revocation information (RI)
  iv. optionally the first user's revocation handle (rh′) if the first user has
  been put on the black list. If the first user is joining for the first time,
  the input rh′ is ⊥ and the algorithm picks a fresh rh.
b. Output:
  i. the witness to the revocation handle (w^{rh}) and the revocation handle
  (rh).
```

In step 261, the first user is joining for the first time and the input rh′ is therefore 1. A step 263 comprises the device 11 of the second user (securely) transmitting the first cryptographic information and second cryptographic information to the device 1 of the first user. Like in the embodiment of FIG. 1, the first cryptographic information comprises the encrypted receiver identifier R_ID (E₂₁(R_ID)). In the embodiment of FIGS. 5 to 9, the second cryptographic information comprises the revocation handle (rh) and the witness to the revocation handle (w^{rh}) obtained in step 261 and the revocation public key (rpk) obtained in step 253 of FIG. 5.

In the embodiment of FIGS. 5 to 9, step 103 of FIG. 1 is implemented by a step 265. Step 265 comprises device 1 receiving the first cryptographic information and the second cryptographic information transmitted in step 263.

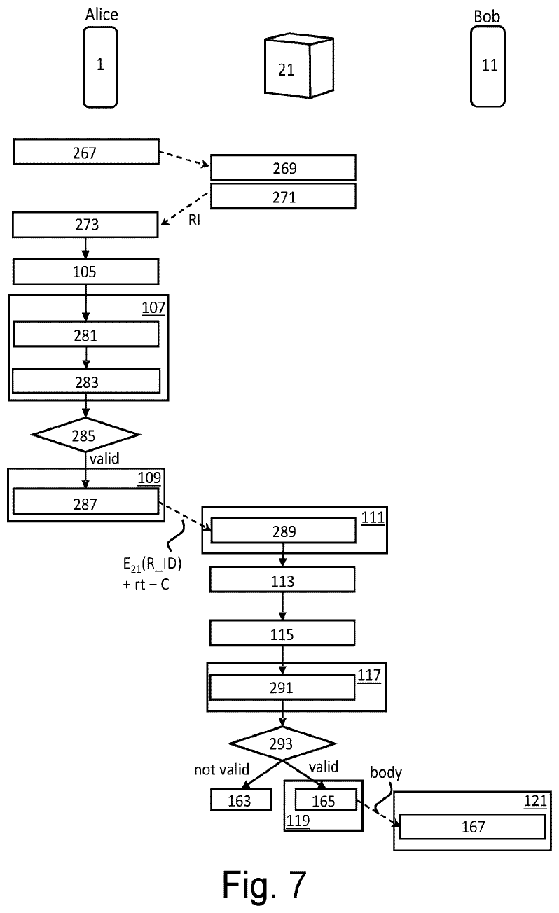

FIG. 7 shows the first user sending a message to the second user after the methods of FIGS. 5 and 6 have been performed. A step 267 comprises the device 1 of the first user transmitting a request for the RI associated with the second user from the privacy routing system 21. As described above, the RI comprises the accumulator value and the other information necessary to generate an up-to-date revocation token rt. The request comprises the first cryptographic information, i.e. the encrypted receiver identifier.

A step 269 comprises the privacy routing system 21 receiving this request. A step 271 comprises the privacy routing system 21 transmitting the RI associated with the second user to the device 1 of the first user. A step 273 comprises the device 1 of the first user receiving the requested RI.

Step 105 comprises the device 1 including the encrypted receiver identifier, as received in step 265, in third cryptographic information. Step 107 comprises determining fourth cryptographic information based on the second cryptographic information. In the embodiment of FIGS. 5 to 9, step 107 is implemented by steps 281 and 283. Step 281 comprises generating the first user's commitment to rh (C) and a decommitment value (o). For each new revocation token rt, the first user generates a fresh commitment to rh in order to avoid making the first user's tokens linkable.

Step 283 comprises the device 1 of the first user running the RevTokenGen algorithm described in the above-mentioned paper “Accumulators with Applications to Anonymity-Preserving Revocation”. The RevTokenGen algorithm has the following input and output:

```
a. Input:
  i. the first user's revocation handle (rh); received in step 265
  ii. the first user's commitment to rh (C); generated in step 281
  iii. a decommitment value (o); generated in step 281
  iv. the revocation information (RI); received in step 273
  v. the first user's witness of rh (w^{rh}); received in step 265
  vi. the revocation public key (rpk); received in step 265
b. Output:
  i. the first user' revocation token (rt), which is a ZKP the first user's
  revocation handle has not been revoked.
```

In the embodiment of FIGS. 5 to 9, the device 1 of the first user generates a new revocation token (and generates a different commitment) every time the first user sends a message to the second user. This ensures unlinkability between different messages sent by the first user. In an alternative embodiment, a new revocation token is generated less often.

A step 285 comprises determining whether a valid token was generated in step 283. This is done be letting the first user run the RevToken Ver algorithm on her own revocation token. If the revocation token is valid, then a step 287 is performed next. Step 287 comprises transmitting a message from the device 1 of the first user to the privacy routing system 21. The message comprises the third cryptographic information determined in step 105 and the fourth cryptographic information determined in step 107. The third cryptographic information comprises the receiver identifier, encrypted with the cryptographic key associated with the privacy routing system (_{E21}(R_ID)). In the embodiment of FIGS. 5 to 9, the fourth cryptographic information comprises the revocation token (rt) generated by the device 1 in step 283 and further comprises the first user's commitment to rh I generated in step 281.

In the embodiment of FIGS. 5 to 9, step 111 of FIG. 1 is implemented by a step 289. Step 289 comprises the privacy routing system 21 receiving the message from the device 1 of the first user, as transmitted in step 287. Step 113 comprises the privacy routing system 21 decrypting the receiver identifier R_ID from the third cryptographic information with the cryptographic key or with the further cryptographic key corresponding to the cryptographic key. Step 115 comprises the privacy routing system 21 identifying the second user based on the receiver identifier decrypted in step 113.

In the embodiment of FIG. 2, step 117 of FIG. 1 is implemented by a step 291. Step 291 comprises the privacy routing system 21 verifying the revocation token (rt), received in step 289, with the cryptographic accumulator, i.e. RI, associated with the identified second user, as received in step 273 of FIG. 7. Specifically, step 291 comprises the privacy routing system 21 running the RevToken Ver algorithm described in the above-mentioned paper “Accumulators with Applications to Anonymity-Preserving Revocation”. The RevToken Ver algorithm has the following input and output:

```
a. Input:
  i. the first user's revocation token (rt); received in step 289
  ii. the first user's commitment to rh (C); received in step 289
  iii. the revocation information (RI); received in step 257
  iv. the revocation public key (rpk); received in step 257
b. Output:
  i. Either 0 or 1. If 0: the revocation token is not valid. If 1: the
  revocation token is valid.
```

A step 293 comprises checking whether the revocation token was determined to be valid or not in step 291. If the revocation token is not valid, step 163 is performed. Step 163 comprises dropping the message. If the revocation token is valid, step 119 is performed. In the embodiment of FIGS. 5 to 9, step 119 is implemented by step 165. Step 165 comprises the privacy routing system 21 forwarding the message from the privacy routing system 21 to the device 11 of the second user. Step 121 comprises the device 11 of the second user receiving the message from the device 1 of the first user via the privacy routing system 21. In the embodiment of FIGS. 5 to 9, step 121 is implemented by a step 167. In step 167, only the body of the message is received.

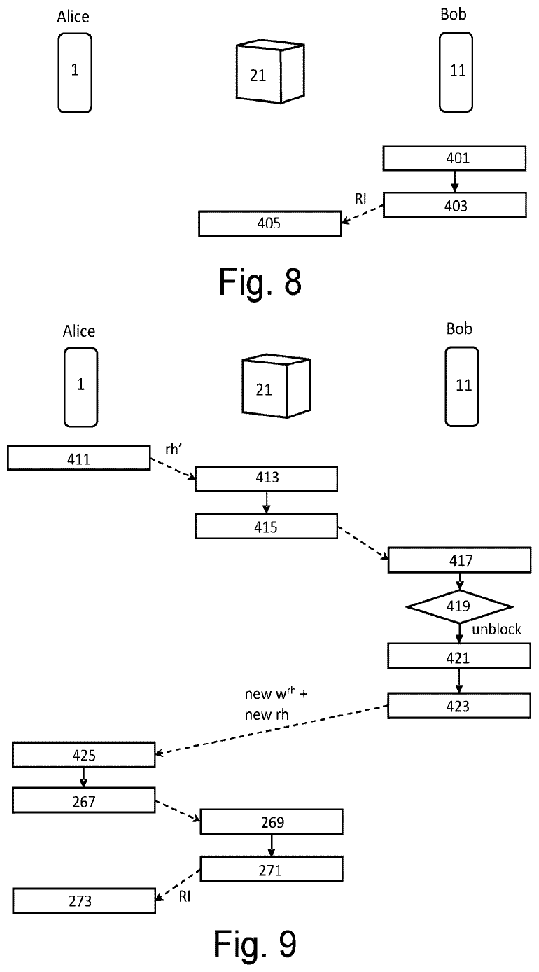

FIG. 8 shows the second user adding the first user to a blacklist after the methods of FIGS. 5 and 6 have been performed. A step 401 comprises the device 11 of the second user running the Revoke algorithm described in the above-mentioned paper “Accumulators with Applications to Anonymity-Preserving Revocation”. The Revoke algorithm has the following input and output:

```
a. Input:
  i. the revocation handle of the first user that the second user wants to
  blacklist (and thus wants to add to the accumulator) (rh)
  ii. the revocation secret key (rsk)
  iii. the revocation information (RI)
b. Output:
  ii. updated revocation information (RI) = (
  1. updated accumulator value (a),
  2. updated list of all update messages (M) ,
  3. a new signature (σ),
  )
```

A step 403 comprises the device 11 of the second user transmitting the updated revocation information (RI) to the privacy routing system 21. A step 405 comprises the privacy routing system 21 receiving the updated revocation information. When the method of FIG. 7 is performed after the method of FIG. 8 has been performed, the token generated in step 283 will be determined not to be valid when step 285 of FIG. 7 is performed.

FIG. 9 shows the first user transmitting a request to be removed from the second user's blacklist. This is an optional extension of the steps of FIGS. 5 to 7 and may be omitted. A step 411 comprises the device 1 of the first user transmitting a request to be removed from the first user's blacklist to the privacy routing system 21. The first user previously received a revocation handle (rh) in step 265 and includes this revocation handle in the request. The request further comprises the third cryptographic information, i.e. the encrypted receiver identifier.

A step 413 comprises the privacy routing system 21 receiving this request and a step 415 comprises the privacy routing system 21 forwarding this request to the device 11 of the second user without the third cryptographic information. The privacy routing system 21 and the second user may have agreed on a maximum amount of Join-while-still-revoked-requests that will be forwarded by the privacy routing system to a device of the second user. A step 417 comprises the device 11 of the second user receiving the forwarded request. A step 419 comprises the device 11 of the second user determining whether to remove the first user from the blacklist, as requested by the first user.

If the second user agrees to remove the first user from the second user's blacklist, a step 421 is performed next. Step 421 comprises the device 11 of the second user running the Join algorithm again. The Join algorithm has been described above in relation to step 261. This time, there is an existing revocation handle for the first user, which has been received in step 417. This revocation handle is provided to the algorithm as input (rh′). Then, a step 423 comprises the device 11 of the second user (securely) transmitting the new revocation handle (rh) and the new witness to the revocation handle (w^{rh}) obtained in step 421.

A step 425 comprises device 1 receiving the new revocation handle (rh) and the new witness to the revocation handle (w^{rh}) transmitted in step 423. Steps 423 and 425 are somewhat similar to steps 263 and 265 of FIG. 6, except that it is not necessary to transmit the encrypted receiver identifier and the revocation public key (rpk), as these have not changed. After step 425, steps 267-273 are performed in the same way as described in relation to FIG. 7.

In the embodiment of FIGS. 5 to 9, an ARC is implemented together with a Join algorithm based on a negative cryptographic dynamic accumulator ACCN to allow the second user to put the first user on (and also off again, if desired) a blacklist. In an alternative embodiment, an ARC is implemented together with a Join algorithm based on a positive cryptographic dynamic accumulator ACCP to allow the second user to put the first user on (and also off again, if desired) a whitelist. In this alternative embodiment, the device 1 of the first user will run the RevTokenGen algorithm to obtain a revocation token proving the first user is on the whitelist (instead of not on the blacklist).

Instead of using a dynamic accumulator, an additive accumulator may be used in case of blacklisting. This disables the possibility to rejoin after being blocked, but makes the communication a bit faster. Instead of using a dynamic accumulator, a subtractive accumulator may be used in case of whitelisting. However, this means that if a first person is not on the initial white list of a second person, this first person is not able to setup communication with this second person. The Join protocol is then no longer used.

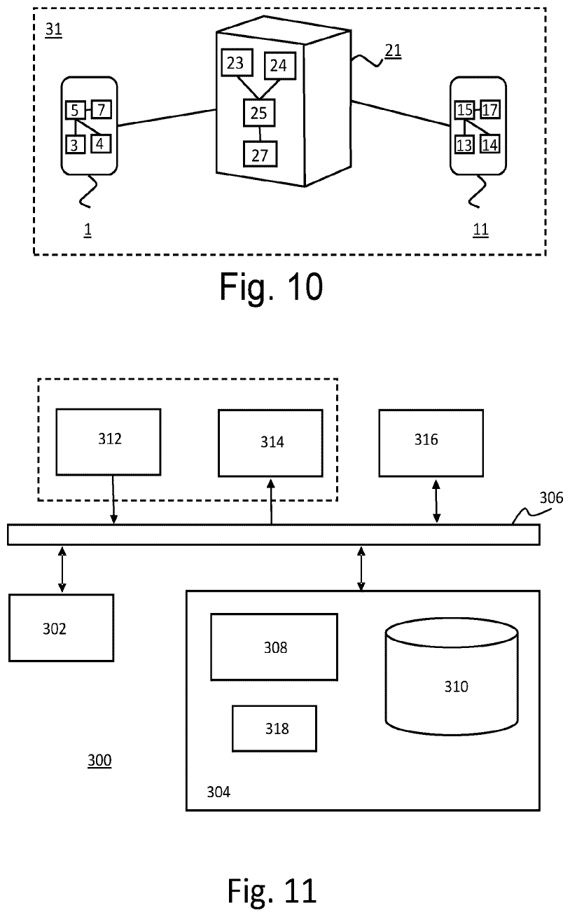

An embodiment of a messaging system 31, which comprising a privacy routing system 21, a device 1 of a first user, and a device 11 of a second user, is shown in FIG. 10. The first and second user devices 1 and 11 may comprise one or more mobile devices, e.g. mobile phones, and/or one or more stationary devices, e.g. desktop PCs.

The privacy routing system 21 comprises a receiver 23, a transmitter 24, a processor 25, and a memory 27. The processor 25 is configured to receive, via the receiver 23, a message from the device 1 of the first user. The message comprises third cryptographic information and fourth cryptographic information. The third cryptographic information comprises a receiver identifier encrypted with the cryptographic key associated with the privacy routing system 21.

The processor 25 is further configured to decrypt the receiver identifier from the third cryptographic information with the cryptographic key or with a further cryptographic key corresponding to the cryptographic key, identify a second user based on the decrypted receiver identifier, validate the fourth cryptographic information, and forward, via the transmitter 24, the message to the device 11 of the second user based on a result of the validation of the fourth cryptographic information.

The second user device 11 comprises a receiver 13, a transmitter 14, a processor 15, and a memory 17. The processor 15 is configured to transmit, via the transmitter 14, first cryptographic information and second cryptographic information to the device 1 of the first user. The first cryptographic information comprises a receiver identifier encrypted with a cryptographic key associated with the privacy routing system 21. The receiver identifier is associated with the second user. The processor 15 is further configured to receive, via the receiver 13, a message from the device 1 of the first user via the privacy routing system 21.

The first user device 1 comprises a receiver 3, a transmitter 4, a processor 5, and a memory 7. The processor 5 is configured to receive, via the receiver 3, first cryptographic information and second cryptographic information. The first cryptographic information comprises a receiver identifier encrypted with a cryptographic key associated with the privacy routing system 21. The receiver identifier is associated with the second user.

The processor 5 is further configured to include the receiver identifier, encrypted with the cryptographic key associated with the privacy routing system, in third cryptographic information, determine fourth cryptographic information based on the second cryptographic information, and transmit, via the transmitter 4, a message for the second user to the privacy routing system 21. The message comprises the third cryptographic information and the fourth cryptographic information.

In a first implementation of the messaging system 31, the processor 5 of the user device 1 is configured to perform steps 153, 105, 107, and 155 of FIG. 2, the processor 25 of the privacy routing system 21 is configured to perform steps 140, 141, 143, 157, 113, 115, 159, 161, 163, and 165 of FIG. 2, and the processor 15 of the user device 11 is configured to perform steps 145, 147, 149, 151, and 167 of FIG. 2.

In a second implementation of the messaging system 31, the processor 5 of the user device 1 is configured to perform steps 211, 105, 107, and 215 of FIGS. 3 and 4, the processor 25 of the privacy routing system 21 is configured to perform steps 141, 193, 207, 217, 113, 115 (including sub step 219), 221, 223, 225, and 227 of FIGS. 3 and 4, and the processor 15 of the user device 11 is configured to perform steps 195, 201, 203, 205, 209, 229, 231, 233, 235, 237, and 239 of FIGS. 3 and 4.

In a third implementation of the messaging system 31, the processor 5 of the user device 1 is configured to perform steps 265, 267, 273, 105, 281, 283, 285, 287, 411, and 425 of FIGS. 5 to 9, the processor 25 of the privacy routing system 21 is configured to perform steps 141, 193, 257, 269, 271, 289, 113, 115, 291, 293, 163, 165, 405, 413, and 415 of FIGS. 5 to 9, and the processor 15 of the user device 11 is configured to perform steps 195, 251, 253, 255, 261, 263, 167, 401, 403, 417, 419, 421, and 423 of FIGS. 5 to 9.

Optionally, the user device 1 is not only configured to transmit messages but also to receive messages. In this case, the processor 5 of the user device 1 may be configured in the same way as described above in relation to the processor 15 of user device 11. Optionally, the user device 11 is not only configured to receive messages but also to transmit messages. In this case, the processor 15 of the user device 11 may be configured in the same way as described above in relation to the processor 5 of user device 1. Thus, the processor 5 of the user device 1 and the processor 15 of the user device 11 may be configured in the same way.

In the embodiment shown in FIG. 10, the privacy routing system 21 comprises one processor 25. In an alternative embodiment, the privacy routing system 21 comprises multiple processors. The processor may be a general-purpose processor, e.g., an Intel or an AMD processor, or an application-specific processor, for example. The processor may comprise multiple cores, for example. The processor may run a Unix-based or Windows operating system, for example. The memory 27 may comprise solid state memory, e.g., one or more Solid State Disks (SSDs) made out of Flash memory, or one or more hard disks, for example.

The receiver 23 and the transmitter 24 may use one or more communication technologies (wired or wireless) to communicate with other devices on the Internet. The receiver and the transmitter may be combined in a transceiver. The privacy routing system 21 may comprise other components typical for a network server, e.g., a power supply.

In the embodiments shown in FIG. 10, the user devices 1 and 11 comprise one processor 5 and one processor 15, respectively. In an alternative embodiment, one or more of the user devices 1 and 11 comprise multiple processors. The processors 5 and 15 may be general-purpose processors, e.g., ARM, Qualcomm, AMD, or Intel processors, or application-specific processors. The processors 5 and 15 may run Google Android, Apple iOS, a Unix-based operating system or Windows as operating system, for example.

The receivers 3 and 13 and the transmitters 4 and 14 of the user devices 1 and 11, respectively, may use one or more wired or wireless communication technologies such as Ethernet, Wi-Fi, LTE, and/or 5G New Radio to communicate with other devices on the Internet via an access point/base station. The receiver and the transmitter of a user device may be combined in a transceiver. The user devices 1 and 11 may comprise other components typical for a user device, e.g., a display and/or a microphone.

FIG. 11 depicts a block diagram illustrating an exemplary data processing system that may perform the method as described with reference to FIGS. 1-9.

As shown in FIG. 11, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 11 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 11, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 11) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of routing messages via a privacy routing system, the method comprising:
receiving first cryptographic information and second cryptographic information at a device of a first user, the first cryptographic information comprising a receiver identifier encrypted with a cryptographic key associated with the privacy routing system, the receiver identifier being associated with a second user;
transmitting a message from the device of the first user to the privacy routing system, the message comprising third cryptographic information and fourth cryptographic information, the third cryptographic information comprising the receiver identifier encrypted with the cryptographic key associated with the privacy routing system, the fourth cryptographic information having been determined based on the second cryptographic information;
decrypt, at the privacy routing system, the receiver identifier from the third cryptographic information with the cryptographic key or with a further cryptographic key corresponding to the cryptographic key;
identifying, at the privacy routing system, the second user based on the decrypted receiver identifier;
validating the fourth cryptographic information; and
forwarding the message from the privacy routing system to a device of the second user based on a result of the validation of the fourth cryptographic information.

2. A first user device comprising at least one processor configured to:
receive first cryptographic information and second cryptographic information, the first cryptographic information comprising a receiver identifier encrypted with a cryptographic key associated with a privacy routing system, the receiver identifier being associated with a second user,
include the receiver identifier encrypted with the cryptographic key associated with the privacy routing system in third cryptographic information,
determine fourth cryptographic information based on the second cryptographic information, and
transmit a message for a second user to the privacy routing system, the message comprising the third cryptographic information and the fourth cryptographic information.

3. The first user device as claimed in claim 2, wherein the at least one processor is configured to:
determine the fourth cryptographic information by re-randomizing the second cryptographic information, and/or
determine the third cryptographic information by re-randomizing the first cryptographic information.

4. The first user device as claimed in claim 2, wherein the second cryptographic information comprises one or more predefined values encrypted with a sender-specific cryptographic key associated with the second user and specific to the first user and the fourth cryptographic information comprises the second cryptographic information or a randomization of the second cryptographic information.

5. The first user device as claimed in claim 2, wherein the second cryptographic information comprises a public key associated with the second user and specific to the first user and the fourth cryptographic information comprises one or more predefined values encrypted with said public key.

6. A second user device comprising at least one processor configured to:
transmit first cryptographic information and second cryptographic information to a device of a first user, the first cryptographic information comprising a receiver identifier encrypted with cryptographic key associated with a privacy routing system, the receiver identifier being associated with a second user, and
receive a message from the device of the first user via the privacy routing system.

7. The second user device as claimed in claim 6, wherein the message comprises fourth cryptographic information which was determined based on the second cryptographic information and the at least one processor is configured to:
obtain one or more non-blocked-sender-specific cryptographic information items from a memory,
attempt—to decrypt the fourth cryptographic information with the one or more non-blocked-sender-specific cryptographic information items,
drop—the message if the attempt to decrypt the fourth cryptographic information does not result in the one or more pre-defined values, and
present—the message to the user via a user interface if the attempt to decrypt the fourth cryptographic information results in one or more pre-defined values and/or is successful.

8. The second user device as claimed in claim 6, wherein the at least one processor is configured to:
receive an encrypted receiver identifier from the privacy routing system, the receiver identifier being encrypted with a cryptographic key associated with the privacy routing system, and
create the first cryptographic information by copying or re-randomizing the encrypted receiver identifier for the first user.

9. The second user device as claimed in claim 6 8, wherein the at least one processor is configured to:
transmit—the first cryptographic information and the second cryptographic information to devices of a plurality of users, the plurality of users including the first user.

10. A privacy routing system for routing messages, the privacy routing system comprising at least one processor configured to:
receive a message from a device of a first user, the message comprising third cryptographic information and fourth cryptographic information, the third cryptographic information comprising a receiver identifier encrypted with a cryptographic key associated with the privacy routing system,
decrypt the receiver identifier from the third cryptographic information with the cryptographic key or with a further cryptographic key corresponding to the cryptographic key,
identify a second user based on the decrypted receiver identifier,
validate the fourth cryptographic information, and
forward the message to a device of the second user based on a result of the validation of the fourth cryptographic information.

11. The privacy routing system as claimed in claim 10, wherein the fourth cryptographic information comprises a sender identifier encrypted with the cryptographic key or with a second cryptographic key associated with the privacy routing system and the at least one processor is configured to validate the fourth cryptographic information by decrypting the fourth cryptographic information with the cryptographic key, with the second cryptographic key, with the further cryptographic key, with another cryptographic key corresponding to the cryptographic key, or with a second further cryptographic key corresponding to the second cryptographic key, and forward the message to a device of the second user in dependence on whether the sender identifier is included in a list of sender identifiers.

12. The privacy routing system as claimed in claim 10, wherein the at least one processor is configured to:
obtain, based on the decrypted receiver identifier, a plurality of blocked-sender-specific cryptographic information items from a memory,
validate the fourth cryptographic information by attempting to decrypt the fourth cryptographic information with the plurality of blocked-sender-specific cryptographic information items,
drop the message if the attempt to decrypt the fourth cryptographic information results in one or more pre-defined values and/or is successful, and
forward the message to a device of the second user if the attempt to decrypt the fourth cryptographic information does not result in the one or more pre-defined values or is not successful.

13. The privacy routing system of claim 10, wherein the fourth cryptographic information comprises a revocation token generated by the device of the first user and the at least one processor is configured to:
obtain a cryptographic accumulator,
validate the fourth cryptographic information by verifying the revocation token with the cryptographic accumulator, and
forward the message to a device of the second user in dependence on whether the revocation token was determined to be valid.

14. The privacy routing system as claimed in claim 10, wherein the at least one processor is configured to receive a forwarding policy from a device of the second user and forward the message to a device of the second user further based on the forwarding policy.

15. A messaging system comprising:
a first user device comprising at least one processor configured to:
receive first cryptographic information and second cryptographic information, the first cryptographic information comprising a receiver identifier encrypted with a cryptographic key, the receiver identifier being associated with a second user,
include the receiver identifier encrypted with the cryptographic key in third cryptographic information,
determine fourth cryptographic information based on the second cryptographic information, and
transmit a message for a second user, the message comprising the third cryptographic information and the fourth cryptographic information;
a privacy routing system comprising at least one processor configured to:
receive the message from the first user device, the message comprising third cryptographic information and fourth cryptographic information, the third cryptographic information comprising a receiver identifier encrypted with the cryptographic key, wherein the cryptographic key is associated with the privacy routing system,
decrypt the receiver identifier from the third cryptographic information with the cryptographic key or with a further cryptographic key corresponding to the cryptographic key,
identify the second user based on the decrypted receiver identifier,
validate the fourth cryptographic information, and
forward the message based on a result of the validation of the fourth cryptographic information; and
a second user device comprising at least one processor configured to:
transmit first cryptographic information and second cryptographic information to the first user device, the first cryptographic information comprising the receiver identifier encrypted with cryptographic key associated with the privacy routing system, the receiver identifier being associated with the second user, and
receive the message from the first user device via the privacy routing system.

16. A non-transitory computer readable medium having stored therein instructions which, when executed by a privacy routing system, cause the privacy routing system to perform the steps of:
receiving a message from a device of a first user, the message comprising third cryptographic information and fourth cryptographic information, the third cryptographic information comprising a receiver identifier encrypted with a cryptographic key associated with the privacy routing system;
decrypting the receiver identifier from the third cryptographic information with the cryptographic key or with a further cryptographic key corresponding to the cryptographic key;
identifying a second user based on the decrypted receiver identifier;
validating the fourth cryptographic information; and
forwarding the message to a device of the second user based on a result of the validation of the fourth cryptographic information.

17. A non-transitory computer readable medium having stored therein instructions which, when executed by a first user device, cause the first user device to perform the steps of:
receiving first cryptographic information and second cryptographic information, the first cryptographic information comprising a receiver identifier encrypted with a cryptographic key associated with a privacy routing system, the receiver identifier being associated with a second user;
including the receiver identifier encrypted with the cryptographic key associated with the privacy routing system in third cryptographic information;
determining fourth cryptographic information based on the second cryptographic information; and
transmitting a message for the second user to the privacy routing system, the message comprising the third cryptographic information and the fourth cryptographic information.

18. A non-transitory computer readable medium having stored therein instructions which, when executed by a second user device, cause the second user device to perform the steps of:
transmitting first cryptographic information and second cryptographic information to a device of a first user, the first cryptographic information comprising a receiver identifier encrypted with a cryptographic key associated with a privacy routing system, the receiver identifier being associated with a second user; and
receiving a message from the device of the first user via the privacy routing system.

19. The method of claim 1, wherein the encrypted receiver identifier is re-randomized before being included in the message.

20. The method of claim 1, wherein validating the fourth cryptographic information comprises decrypting the fourth cryptographic information or attempting to decrypt the fourth cryptographic information or verifying a revocation token comprised in the fourth cryptographic information.
